(19) United States
(12) Patent Application Publication
(10) Pub. No.: US 2010/0168281 A1
(43) Pub. Date: Jul. 1, 2010

(54) Spalling-Preventing Composite Material Composed of Fiber and Powder Having Different Diameters and Melting Points, and High-Strength Refractory Concrete Comprising the Same

(76) Inventors: Joo Ho Lee, Seoul (KR); Soon Jeon Park, Seoul (KR); Jeong Jin Kim, Anyang-si (KR); Kwang Ki Kim, Suwon-si (KR); Hyung Jae Moon, Seoul (KR); Yin Seong Hwang, Osan-si (KR); Yong Jeong, Seoul (KR); Jin Man Choi, Seoul (KR); Jae Kyung Shin, Gwangju-si (KR); Se Hoon Kim, Daejeon (KR); Chang Hyoo Choi, Daejeon (KR); Hui Chan Kim, Daejeon (KR)

Correspondence Address: PARK LAW FIRM, 3255 WILSHIRE BLVD, SUITE 1110, LOS ANGELES, CA, 90010, US

(21) Appl. No.: 12/647,189

(22) Filed: Dec. 24, 2009

(30) Foreign Application Priority Data
Dec. 26, 2008 (KR) 10-2008-0134286

(51) Int. Cl. C08L 29/04; C08L 23/12; C04B 28/02

(52) U.S. Cl. 524/4; 525/241; 525/57; 524/8

(57) ABSTRACT

Disclosed herein are a spalling-preventing composite material composed of fiber and powder, which have different diameters and melting points so as to be capable of realizing the effect of preventing spalling of high-strength concrete and the effect of improving the fluidity of concrete, and a high-strength refractory concrete comprising the spalling-preventing material. The composite material for preventing spalling of high-strength concrete is composed of powder and fiber at 1:1-3, wherein the powder is a polymer powder having a diameter of 0.10-0.5 mm and a melting point of 110-150° C., and the fiber is a conjugate fiber including a first fiber having a diameter of 0.05-0.10 mm, a length of 5-25 mm and a melting point of 150-190° C., and a second fiber having a diameter of 0.01-0.05 mm, a length of 5-25 mm and a melting point of 190-250° C., the first fiber being a polypropylene fiber, and the second fiber being a nylon fiber or a polyvinyl alcohol fiber.

### BACKGROUND OF THE INVENTION

1. Field of the Invention

The present invention relates to a spalling-preventing material capable of preventing spalling of high-strength concrete and the use thereof, and more particularly to a spalling-preventing composite material composed of fiber and powder, which have different diameters and melting points so as to be capable of realizing the effect of preventing spalling of high-strength concrete and the effect of improving the fluidity of concrete, and to a high-strength refractory concrete comprising the spalling-preventing composite material.

2. Description of the Prior Art

As buildings become higher, larger, and more complex, the demand for high-performance special concrete is gradually increasing. An example of the high-performance special concrete includes high-strength or ultra-high-strength concrete. The high-strength or ultra-high-strength concrete refers to concrete having a strength of more than 40 MPa. To realize the high-strength or ultra-high-strength concrete, a method of increasing the strength of a binder while reducing the water-cement ratio is generally used. Namely, admixtures such as blast furnace slag, fly ash and silica fume are used to increase the amount of hydrates, thus making the internal structure of concrete dense.

However, vapor pressure generated in the high-strength or ultra-high-strength concrete during fire is not easily released to the outside due to the dense internal structure of the concrete. In this case, if the vapor pressure in the concrete exceeds the stress limit of the concrete, so-called concrete spalling in which the surface falls off with a severe explosion will occur. This spalling will be more severe as the strength of concrete is increased to make the internal structure of the concrete denser.

Meanwhile, methods for preventing concrete spalling include a method in which a predetermined amount of spalling-preventing fiber having a melting point lower than the temperature at which the spalling of concrete occurs is incorporated in the manufacture of concrete. According to this method, when the fiber reaches the melting point lower than the spalling temperature of the concrete during fire so as to be melted, the fiber melt is absorbed into the surrounding matrix, so that areas where the fiber has previously existed are formed into pores which are used as channels for the movement of vapor pressure generated in the concrete. In other words, because the smooth movement of vapor pressure through the pores occurs, the internal pressure of the concrete is reduced, whereby the effect of preventing the concrete spalling appears.

However, in order to realize the effect of preventing the spalling of concrete using the fiber, a predetermined amount or more of the fiber must be incorporated into the concrete, and particularly, as the strength of the concrete becomes greater, the amount of fiber incorporated into the concrete must be increased. However, as the amount of fiber incorporated into concrete is increased, the fluidity of the concrete is reduced due to the entanglement of the fiber, leading to a decrease in concrete pumping capacity. Due to the problems associated with concrete pumping, the prior high-strength refractory concrete realizing the effect of preventing concrete spalling only using the fiber is difficult to apply to buildings higher than a certain height, such as high-rise buildings. Accordingly, the present inventor has developed a high-strength refractory concrete which has improved fluidity as a result of reducing the amount of fiber incorporated therein.

### SUMMARY OF THE INVENTION

Accordingly, the present invention has been made in view of the problems occurring in the prior-art high-strength refractory concrete, and it is an object of the present invention to provide a spalling-preventing composite material, which can realize the spalling-preventing effect while reducing the amount of fiber incorporated into concrete and, at the same time, can improve concrete fluidity, and to provide a high-strength refractory concrete comprising the spalling-preventing composite material.

To achieve the above object, according to one aspect of the present invention, there is provided a composite material for preventing spalling of high-strength concrete, the composite material being composed of powder and fiber at a volume ratio of 1:1-3, wherein the powder is a polymer powder having a diameter of 0.10-0.5 mm and a melting point of 110-150° C., and the fiber is a single fiber having a diameter of 0.05-0.10 mm, a length of 5-25 mm and a melting point of 150-190° C., the single fiber being a polypropylene fiber.

According to another aspect of the present invention, there is provided a composite material for preventing spalling of high-strength concrete, the composite material being composed of powder and fiber at 1:1-3, wherein the powder is a polymer powder having a diameter of 0.10-0.5 mm and a melting point of 110-150° C., and the fiber is a conjugate fiber including a first fiber having a diameter of 0.05-0.10 mm, a length of 5-25 mm and a melting point of 150-190 t, and a second fiber having a diameter of 0.01-0.05 mm, a length of 5-25 mm and a melting point of 190-250° C., the first fiber being a polypropylene fiber, and the second fiber being a nylon fiber or a polyvinyl alcohol.

According to yet another aspect of the present invention, there is provided a high-strength refractory concrete wherein the above-described composite material for preventing concrete spalling is incorporated in an amount of 0.1-0.2 vol % based on the volume of the concrete.

According to the present invention, the following effects can be obtained.

First, because the amount of fiber incorporated, which is disadvantageous in terms of fluidity, is decreased, while powder advantageous in terms of fluidity is incorporated, a good-quality, high-strength refractory concrete having improved fluidity can be provided.

Second, because the effect of preventing concrete spalling is maximized through the synergistic effect of fiber and powder, a high-strength refractory concrete having a reduced amount of spalling-preventing material incorporated therein can be provided.

### BRIEF DESCRIPTION OF THE DRAWINGS

The above and other objects, features and advantages of the present invention will be more clearly understood from the following detailed description taken in conjunction with the accompanying drawing, in which:

FIGS. 1a to 1d graphically show slump test results obtained in test examples of the present invention;

FIGS. 2a to 2d graphically show the results of compressive strength tests carried out in test examples of the present invention; and

FIGS. 3a to 3d are photographs showing the results of refractory tests carried out in test examples of the present invention.

### DETAILED DESCRIPTION OF THE INVENTION

The composite material for preventing concrete spalling according to the present invention is technically characterized in that a powder having a large diameter and a low melting point compared to the fiber known in the prior art is used together with the fiber. In other words, the powder together with the fiber is incorporated into a high-strength concrete in order to prevent spalling of the concrete.

Specifically, the present invention provides a composite material for preventing spalling of high-strength concrete, which is composed of powder and fiber at a volume ratio of 1:1-3. On the basis of the results of tests, as the powder, a polymer powder having a diameter of 0.10-0.5 mm and a melting point of 110-150° C. is adopted, and as the fiber, either a single fiber consisting of a first fiber having a diameter of 0.05-0.10 mm, a length of 5-25 mm and a melting point of 150-190° C., or a conjugate fiber which includes a first fiber having a diameter of 0.05-0.10 mm, a length of 5-25 mm and a melting point of 150-190° C. and a second fiber having 0.05-0.10 mm, a length of 5-25 mm and a melting point of 150-190° C. is adopted. Herein, the polymer powder means that the powdery crystal is maintained even in processes of mixing and curing concrete. Also, the first fiber is a polypropylene fiber, and the second fiber is a nylon fiber or a polyvinyl alcohol fiber.

Particularly, when the conjugate fiber is adopted as the fiber in the present invention, the first fiber and the second fiber are preferably used at a volume ratio of 1:1.

As described above, in the present invention, the powder having specific physical properties is used together with the fiber as the material for preventing concrete spalling, wherein the physical properties and conditions of the powder and the fiber are determined in consideration of the relationship between the spalling temperature of concrete and the pore-forming effects of the powder and the fiber. In other words, in the case of the powder, if the diameter is less than 0.1 mm, the effect of forming pores for reducing the internal vapor pressure of concrete will be insufficient, and if the diameter is more than 0.5 nm, the melting time will become longer, such that pore formation can be delayed and, in addition, the fluidity and strength of concrete can be reduced. Moreover, if the melting point of the powder is less than 110° C., the powder can be melted at a too early stage, such that the temperature of concrete can rapidly increase due to fast heat transfer through the pores, and if the melting point is more than 150° C., the powder will be melted together with the fiber, such that the formation of pores for reducing the internal vapor pressure of concrete can be delayed. Also, in the case of the first fiber and the second fiber, the diameter and length are determined in consideration of the fluidity and strength of concrete, and the melting point is determined in consideration of the spalling temperature of concrete.

As described above, according to the present invention, the fiber and the powder, which have specific physical properties, are used together as a material for preventing concrete spalling, and thus the material for preventing concrete spalling will melt stepwise in fire. In other words, the powder having a larger diameter will melt before the fiber having a smaller diameter and a longer length will melt. The stepwise melting contributes to the formation of continuous pores, because spherical pores formed first by the melting of the powder are linked with each other through linear pores formed later by the melting of the fiber. Through a guarantee of the continuity of pores resulting from this temperature change, the spalling of high-strength concrete is effectively prevented.

Meanwhile, a process of mixing high-strength concrete using the concrete spalling-preventing composite material according to the present invention is preferably carried out by mixing the powder and the fiber uniformly with a cement binder, and then mixing the mixture with other materials (water, aggregate, etc.). In other words, the composite material for preventing concrete spalling is premixed with one or more components selected from the group consisting of fly ash, silica fume, blast furnace slag fine powder, cement and the like, which are used as cement binders for high-strength concrete. The premixing process is carried out to uniformly disperse the powder and the fiber, thus maximizing the concrete spalling-preventing effect and fluidity-improving effect thereof. The composite material for preventing concrete spalling is preferably used in an amount of 0.1-0.2 vol % based on the volume of concrete in view of the concrete spalling-preventing effect thereof.

Hereinafter, the present invention will be described in further detail with reference to test examples. It is to be understood, however, that these test examples are illustrative purposes only and are not to be construed to limit the scope of the present invention.

Test Examples: Tests for Physical Properties of High-Strength Refractory Concrete

1. Constituent Materials of High-Strength Refractory Concrete

(1) Material for Preventing Concrete Spalling

To ensure the refractory performance of high-strength refractory concrete, the powder and fiber having the physical properties shown in Table 1 below were used as the constituent materials of a concrete spalling-preventing material.

TABLE 1
Physical properties of spalling-preventing material

| | | | | | Melting |
|---|---|---|---|---|---|
| | | Density | Length | Diameter | point |
| Spalling-preventing material | | (g/cm³) | (mm) | (mm) | (° C.) |
| Powder | Polymer powder | 0.93 | — | 0.25 | 127 |
| First fiber | Polypropylene | 0.91 | 19 | 0.07 | 162 |
| | fiber | | | | |
| Second fiber | Nylon fiber | 1.15 | 12 | 0.02 | 220 |

Polymer powder: FUSABOND E MB 158D 50 POWDER (DuPont)

(2) Concrete Mixing

To examine the refractory performance of high-strength concrete having the powder and fiber incorporated therein, concrete was mixed according to the design of mix proportion shown in Table 2 below, and a spalling-preventing material having the composition shown in Table 3 below was incorporated during the mixing of the concrete. In the composition of the spalling-preventing material in Table 3, the first and second fibers are the same materials as shown in Table 1 above, and the conjugate fiber is composed of the first fiber (polypropylene fiber) and the second fiber (nylon fiber) at a volume ratio of 1:1.

TABLE 2
Mix proportion design of concrete

| Mix | | | | Proportion of mass (kg/cm³) | | | | | |
|---|---|---|---|---|---|---|---|---|---|
| design | W/B | S/A | SP/C | Water | Binder (B) | | | | |
| strength | (%) | (%) | (%) | (W) | C | FA | SF | S | G |
| 80 | 22.5 | 43 | 1.8 | 152 | 507 | 135 | 34 | 660 | 882 |

Cement (C): Common Portland cement produced in Korea
Fine aggregate (S): washed sand
Coarse aggregate (G): 20 mm crushed coarse aggregate
Superplasticizer (SP): Polycarboxylate

TABLE 3
Composition of spalling-preventing material
(ratio of incorporated material to volume of concrete)
Spalling-preventing material

| Ratio of | Ratio of | Ratio of | Ratio of |
|---|---|---|---|
| first fiber | first powder | first fiber:powder | conjugate fiber:powder |
| incorporated | incorporated | incorporated | incorporated |
| (vol %) | (vol %) | (vol %) | (vol %) |
| 0 | 0 | 0 | 0 |
| 0.05 | 0.05 | 0.1:0 | 0.1:0 |
| 0.10 | 0.10 | 0.075:0.025 | 0.075:0.025 |
| 0.15 | 0.15 | 0.05:0.05 | 0.05:0.05 |
| 0.20 | 0.20 | 0.025:0.075 | 0.025:0.075 |
| — | — | 0:0.1 | 0:0.1 |

2. Results of Physical Property Tests for Concrete

(1) Tests for Physical Properties of Concrete

In order to examine if the concrete mixed according to the formulas of Tables 2 and 3 as described above can be used in practice as high-strength refractory concrete, the slump flow of uncured concrete was tested, and the compressive strength (day 28) and refractory performance of cured concrete were tested.

(2) Slump Flow of Uncured Concrete

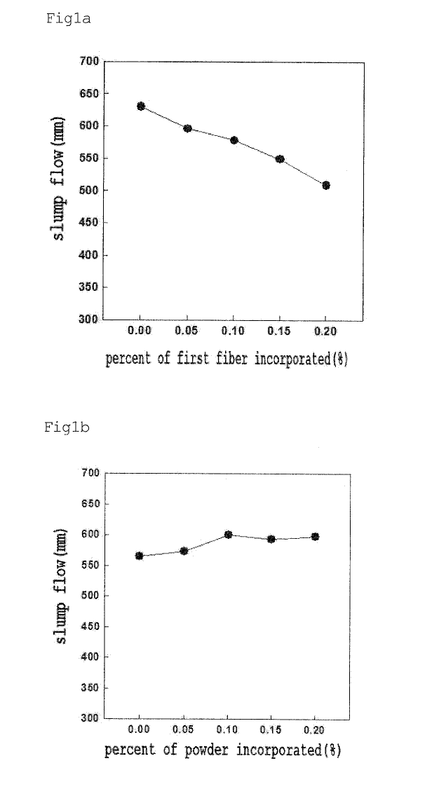

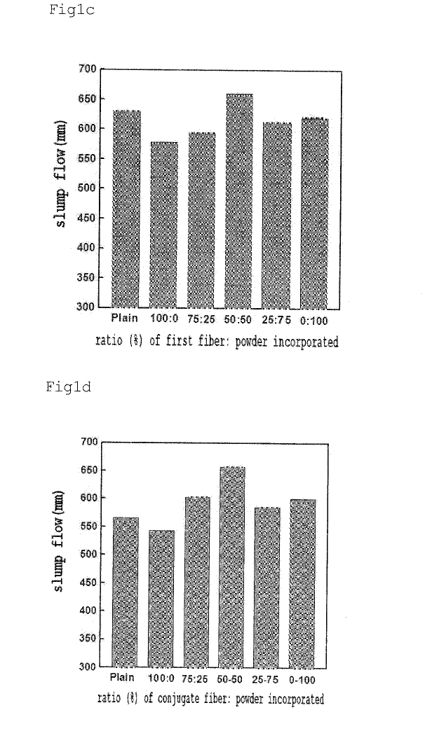

FIGS. 1a to 1c show the change in slump flow according to the change in the kind of spalling-preventing material and the change in the ratio of spalling-preventing material incorporated.

As shown in FIG. 1a, the case in which only the first fiber was incorporated as the spalling-preventing material, the slump flow of the concrete was decreased with the increase in the ratio of first fiber incorporated. This is believed to be because of the increase in viscosity caused by the increase of the fiber, and the entanglement of the fiber.

As shown in FIG. 1b, in the case in which only the powder was incorporated as the spalling-preventing material, the slump flow of the concrete was increased with the increase in the ratio of powder incorporated. This suggests that the powder is effective in improving the fluidity of concrete.

As shown in FIG. 1c, in the case in which the first fiber and the powder were incorporated together as the spalling-preventing material, the slump flow of the concrete was decreased compared to the case in which the spalling-preventing material was not incorporated (plain). However, as the ratio of the powder in the mixture of the first fiber and the powder was increased, the slump flow was greatly improved compared to the case in which only the first fiber was incorporated as the spalling-preventing material, and when the ratio of the powder exceeded 50%, the slump flow approached to that of plain.

As shown in FIG. 1d, in the case in which the conjugate fiber (first fiber: second fiber=1:1) and the powder were incorporated together as the spalling-preventing material, the slump flow of the concrete was increased compared to the case in which only the conjugate fiber was incorporated as the spalling-preventing material (100:0) and compared to the case of plain. Also, the ratio of the powder in the mixture of the conjugate fiber and the powder was increased, the slump flow was increased.

Particularly, as can be seen in FIGS. 1c and 1d, when the spalling-preventing material composed of the first fiber or the conjugate fiber and the powder at a volume ratio of 1:1 was incorporated (50:50), the slump flow was rapidly increased.

Putting the above results together, it can be concluded that the case of incorporating the first fiber or the conjugate fiber together with the powder as the spalling-preventing material is more advantageous for improving the fluidity of concrete compared to the case of incorporating only the first fiber or the conjugate fiber.

(3) Compressive Strength of Cured Concrete

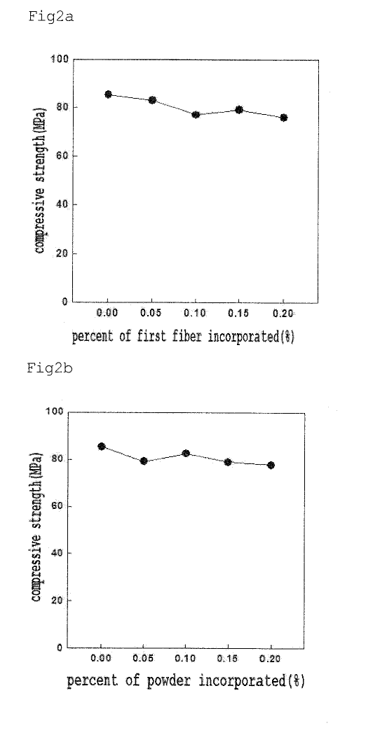

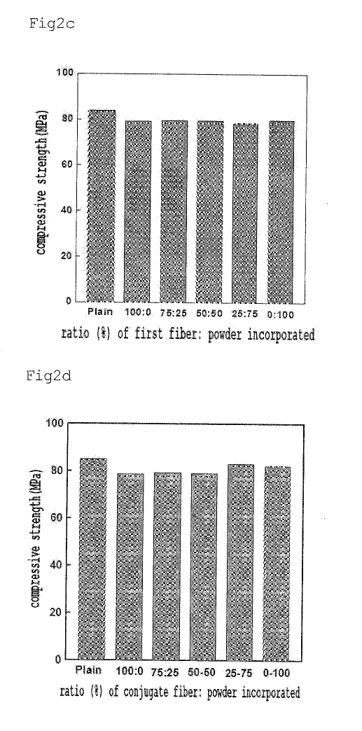

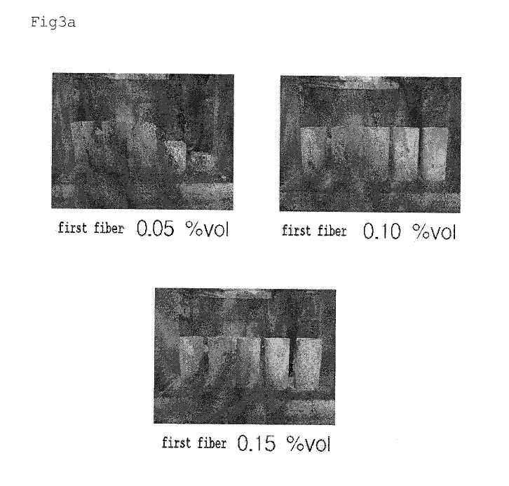

FIGS. 2a to 2d show the change in compressive strength at day 28 according to the change in the kind of spalling-preventing material and the change in the incorporation ratio of the spalling-preventing material.

As shown in FIGS. 2a and 2b, in the case in which only the first fiber was incorporated as the spalling-preventing material and in the case in which only the powder was incorporated as the spalling-preventing material, the compressive strength of the concrete was somewhat decreased due to the incorporation of the first fiber or the powder.

As shown in FIG. 2c, in the case in which the first fiber and the powder were incorporated together as the spalling-preventing material, the compressive strength of the concrete was slightly decreased compared to the case in which the spalling-preventing material was not incorporated (plain). However, the compressive strength in the case of incorporating first fiber together with the powder was not greatly different from that in the case of incorporating only the first fiber as the spalling-preventing material (100:0). In this case, the compressive strength was substantially constant regardless of the ratio of the powder.

As shown in FIG. 1d, in the case in which the conjugate (first fiber: second fiber=1:1) were incorporated together as the spalling-preventing material, the compressive strength showed a pattern similar to that in the case of incorporating the first fiber and the powder as the spalling-preventing material.

Putting the above results together, it can be concluded that the case of incorporating the first fiber or the conjugate fiber alone as the spalling-preventing material and the case of incorporating the first fiber or the conjugate fiber together with the powder as the spalling-preventing material are similar to each other in terms of ensuring the compressive strength of concrete.

(4) Refractory Performance of Cured Concrete

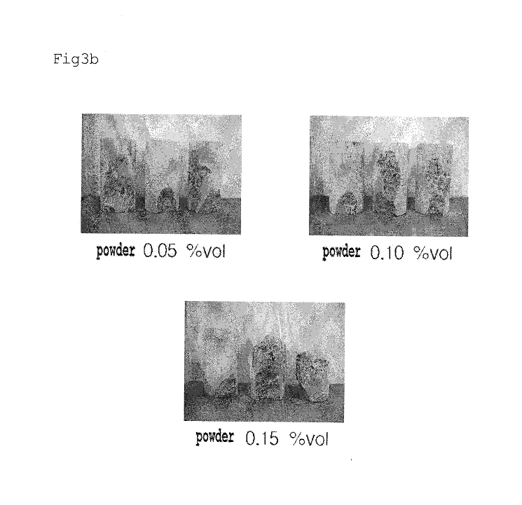

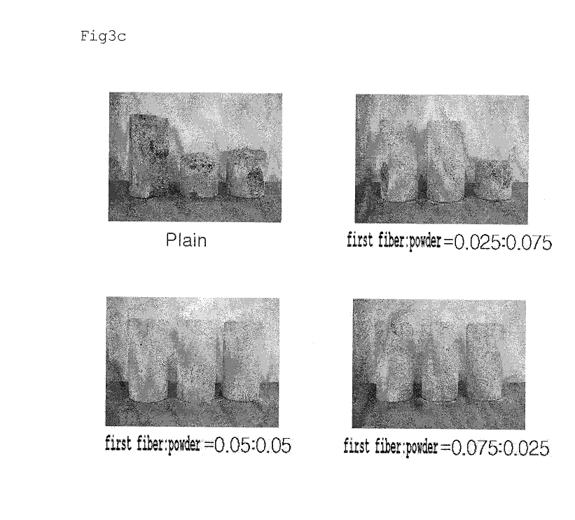

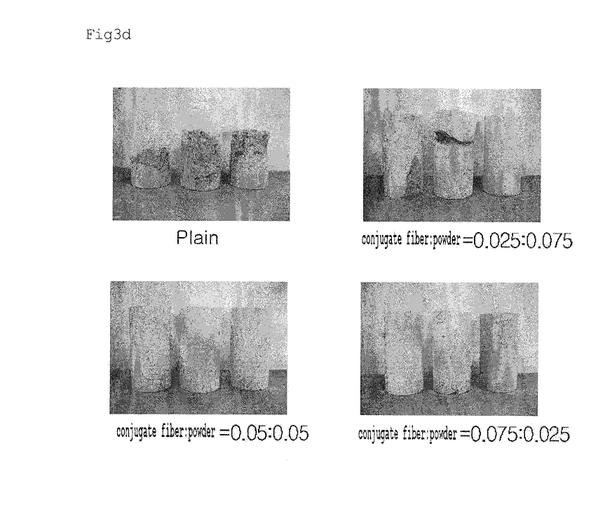

FIGS. 3a to 3d show spalling patterns according to the change in the kind of spalling-preventing material and the change in the incorporation ratio of the spalling-preventing material.

FIG. 3a shows spalling patterns in the case in which only the first fiber was incorporated as the spalling-preventing material. As shown therein, the case of incorporating the first fiber in an amount of 0.05 vol % showed severe explosive spalling, the case of incorporating the first fiber in an amount of more than 0.10 vol % showed some non-explosive spalling, and the case of incorporating the first fiber in an amount of more than 0.15 vol % showed spalling prevention. This suggests that, in order for high-strength concrete having a strength of more than 80 MPa to have refractory performance, it is necessary to incorporate the fiber in an amount of more than 0.15 vol %.

FIG. 3b shows spalling patterns in the case in which only the powder was incorporated as the spalling-preventing material. As shown therein, even if the ratio of powder incorporated was increased, the spalling-preventing effect was not sufficiently exhibited, and some explosive and non-explosive spalling occurred.

FIG. 3c shows spalling patterns in the case in which the first fiber and the powder were incorporated together as the spalling-preventing agent, and FIG. 3d shows palling patterns in the case in which the conjugate fiber (first fiber: second fiber=1:1) and the powder were incorporated together as the spilling-preventing material. As shown therein, in the case in which the spalling-preventing material was not incorporated plain), severe explosive spalling occurred, and in the case in which the spalling-preventing material composed of the fiber (first fiber or conjugate fiber) and the powder at a ratio of 0.025:0.075 was incorporated in an amount of 0.10 vol % based on the volume of concrete, some explosive and non-explosive spalling of the concrete occurred. However, in the case in which the spalling-preventing material composed of the fiber (first fiber or conjugate fiber) at a ratio of 0.05:0.05 or 0.075:0.025 was incorporated in an amount of 0.10 vol % based on the volume of concrete, the spalling of the concrete was prevented. In other words, it could be seen that, even when the first fiber or the conjugate fiber was incorporated in an amount of less than 0.10 vol % based on the volume of concrete, the effect of preventing spalling of the concrete appeared.

Putting the above results together, it can be concluded that the case of incorporating the first fiber or the conjugate fiber together with the powder as the spalling-preventing material is more advantageous for exhibiting the spalling-preventing effect in view of the amount of spalling-preventing material or fiber incorporated compared to the case of incorporating only the first fiber or the conjugate fiber.

(5) Comprehensive Evaluation of Physical Properties of Concrete

When the test results for the slump flow, compressive strength and refractory performance of concrete are put together, it is concluded that the case of incorporating the first fiber or the conjugate fiber together with the spalling-preventing material is more effective in improving concrete fluidity and exhibiting the concrete spalling-preventing effect in view of the amount of spalling-preventing material or fiber incorporated compared to the case of incorporating only the first fiber or the conjugate fiber.

Although the preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A composite material for preventing spalling of high-strength concrete, the composite material being composed of powder and fiber at a volume ratio of 1:1-3, wherein the powder is a polymer powder having a diameter of 0.10-0.5 mm and a melting point of 110-150° C., and the fiber is a single fiber having a diameter of 0.05-0.10 mm, a length of 5-25 mm and a melting point of 150-190° C., the single fiber being a polypropylene fiber.

2. A composite material for preventing spalling of high-strength concrete, the composite material being composed of powder and fiber at 1:1-3, wherein the powder is a polymer powder having a diameter of 0.10-0.5 mm and a melting point of 110-150° C., and the fiber is a conjugate fiber including a first fiber having a diameter of 0.05-0.10 mm, a length of 5-25 mm and a melting point of 150-190° C., and a second fiber having a diameter of 0.01-0.05 mm, a length of 5-25 mm and a melting point of 190-250° C., the first fiber being a polypropylene fiber, and the second fiber being a nylon fiber or a polyvinyl alcohol fiber.

3. The composite material of claim 2, wherein the volume ratio of the first fiber to the second fiber in the conjugate fiber is 1:1.

4. A high-strength refractory concrete wherein a spalling-preventing composite material according to any one of claim 3 is incorporated in an amount of 0.1-0.2 vol % based on the volume of the concrete.

5. A high-strength refractory concrete wherein a spalling-preventing composite material according to any one of claim 2 is incorporated in an amount of 0.1-0.2 vol % based on the volume of the concrete.

6. A high-strength refractory concrete wherein a spalling-preventing composite material according to any one of claim 1 is incorporated in an amount of 0.1-0.2 vol % based on the volume of the concrete.
